(19) United States
(12) Patent Application Publication
(10) Pub. No.: US 2014/0168611 A1
(43) Pub. Date: Jun. 19, 2014

(54) LASER PROJECTION DEVICE

(71) Applicant: HON HAI PRECISION INDUSTRY CO., LTD., New Taipei (TW)

(72) Inventor: KAI-WEN WU, New Taipei (TW)

(73) Assignee: HON HAI PRECISION INDUSTRY CO., LTD., New Taipei (TW)

(21) Appl. No.: 13/873,124

(22) Filed: Apr. 29, 2013

(30) Foreign Application Priority Data
Dec. 13, 2012 (TW) 101147265

(51) Int. Cl. G03B 21/14

(52) U.S. Cl. CPC G03B 21/142
USPC 353/31

(57) ABSTRACT

A laser projection device includes a blue laser chip, a red laser chip and a green laser chip and a spectroscope arranged on light paths of laser beams emitted from the laser chips. The laser projection device further includes a substrate. The laser chips are mounted on the substrate. The laser beams emitted from the laser chips are converged by a lens to reach the spectroscope and then reflected by the spectroscope to mix together.

### BACKGROUND

1. Technical Field

The disclosure generally relates to projection devices and more particularly to a laser projection device.

2. Description of Related Art

Laser projection devices are more and more popular for its projected images having a lager color gamut, a higher brightness, an increased contrast and a better saturation.

A conventional laser projection device includes a red light emitting diode (LED) package, a green LED package, a blue LED package, a spectroscope arranged on light paths of the LED packages and a photoelectric conversion device. Light emitted from the LED packages directly radiates to the spectroscope and then is reflected by the spectroscope to mix. And then, the mixed light can be modulated into images on a screen by the photoelectric conversion device. However, light emitted from the LED packages directly radiating into the spectroscope easily results in a light interference, which may seriously affect the performance of the laser projection device.

What is needed, therefore, is an improved laser projection device which can overcome the above described shortcomings

### BRIEF DESCRIPTION OF THE DRAWINGS

FIG. 1 is a top view of a laser projection device according to a first embodiment.

FIG. 2 is a schematic view showing light paths of the laser projection device of FIG. 1.

FIG. 3 is a schematic view showing light paths of a laser projection device according to a second embodiment.

### DETAILED DESCRIPTION

Embodiments of laser projection device will now be described in detail below and with reference to the drawings.

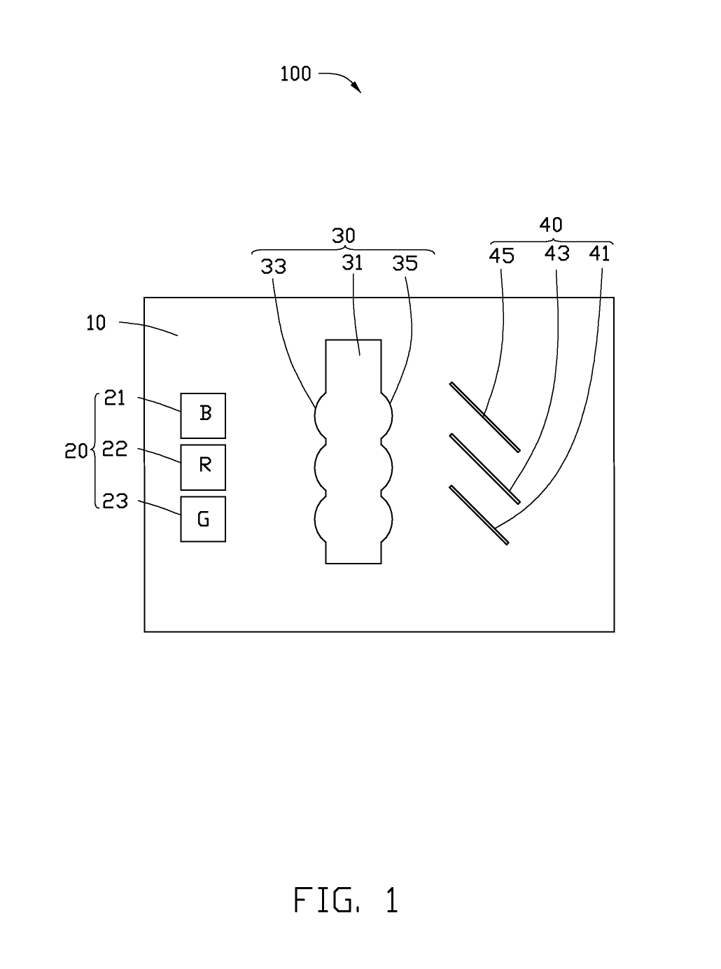

Referring to FIG. 1, a laser projection device 100 according to a first embodiment of the present disclosure includes a substrate 10, a light source 20, a lens 30 and a spectroscope 40. The light source 20, the lens 30 and the spectroscope 40 are mounted on the substrate 10. The spectroscope 40 is arranged on light paths of lights emitted from the light source 20. The lens 30 is located between the light source 20 and the spectroscope 40.

The substrate 10 is flat. The light source 20, the lens 30 and the spectroscope 40 are arranged on a top surface of the substrate 10 in series along a longitudinal direction of the substrate 10. A circuit (not shown) is arranged on the top surface of the substrate 10. In this embodiment, the substrate 10 is made of electrically insulating materials, such as silicone, epoxy.

The light source 20 includes a plurality of laser chips. The laser chips are mounted on the top surface of the substrate 10. The laser chips are spaced from each other, and they are electrically connected to the circuit on the top surface of the substrate 10. A brightness of the laser chips can be controlled by a current flow through the circuit. The light source 20 is used to emit laser beams with colors needed.

In this embodiment, the light source 20 includes a blue laser chip (B) 21, a red laser chip (R) 22 and a green laser chip (G) 23. Each laser chip 21, 22, 23 is a laser diode. The blue laser chip (B) 21, red laser chip (R) 22, and the green laser chip (G) 23 are spaced from each other and arranged in a line along a transverse direction of the substrate 10. Alternatively, the arranged direction and the arranged sequence of the laser chips 21, 22, 23 are not limited.

The lens 30 is spaced from the light source 20, and located on the light paths of the light source 20. The lens 30 is made of materials with a consistent refractive index. The lens 30 is used to refract laser beams emitted from the light source 20 convergently into the spectroscope 40.

The lens 30 includes a main body 31, a plurality of first light concentrating parts 33 and a plurality of second light concentrating parts 35. In the first embodiment, the first light concentrating parts 33 and the second light concentrating parts 35 are integrally formed on opposite sides of the main body 31 and symmetrical relative to a middle line (not shown) of the main body 31 and so that a pair of first and second light concentrating parts 33, 35 is in line with a corresponding laser chip 21 (22, 23).

The main body 31 is cuboid. A longitudinal direction of the main body 31 is parallel to the transverse direction of the substrate 10.

Each of the first light concentrating part 33 is hemispherical. The first light concentrating parts 33 are protruding from a surface of the main body 31 facing the light source 20, and spaced from each other. In this embodiment, the number of the first light concentrating parts 33 is three. Each of first light concentrating parts 33 is aligned with a corresponding laser chip 21 (22, 23) along a longitudinal direction of the substrate 10.

The first light concentrating part 33 is used to refract laser beams emitted from a laser chip 21 (22, 23) corresponding with the first light concentrating part 33. As such, an interference of the laser beams emitted from the blue laser chip 21, the red laser chip 22 and the green laser chip 23 is reduced. Preferably, the laser beams emitted from each of the laser chips 21, 22, 23 are refracted by the corresponding first light concentrating part 33 to form parallel laser beams. The first light concentrating parts 33 are not limited to the shown hemispherical shape, as long as the interference of the laser beams are reduced by the first light concentrating parts 33.

The second light concentrating parts 35 are protruding from an opposite surface of the main body 31 facing the spectroscope 40 and spaced from each other. Each second light concentrating part 35 has a same shape and a same size to the first light concentrating part 33. Each second light concentrating part 35 is corresponding with a first concentrating part 33 along a longitudinal direction of the substrate 10. In the first embodiment, the number of the second light concentrating parts 35 is three.

Each of the second light concentrating parts 35 is hemispherical. The second light concentrating parts 35 are used to concentrate parallel laser beams from the corresponding first light concentrating parts 33 on the spectroscope 40. Alternatively, both of the first light concentrating parts 33 and the second light concentrating parts 35 can be Fresnel lenses, respectively.

The spectroscope 40 includes three beam splitters 41, 43, 45 respectively facing the laser chips 21, 22, 23 to refract the laser beams emitted from the laser chips 21, 22, 23. The beam splitters 41, 43, 45 are aligned with, parallel to and spaced from each other. The beam splitters 41, 43, 45 are slantwise and top ends thereof oriented toward the light source 20. An angle is defined between each of the beam splitters 41, 43, 45 and a top end of the substrate 10. The angle is varied between 10° to 45°. The laser beams emitted from the laser chips 21, 22, 23 are refracted by the beam splitters 41, 43, 45 to be oriented toward the same direction and mixed together to obtain light of a predetermined color which usually is white.

The beam splitter 41 faces the green laser chip 23 and can reflect the green laser beams and laser beams whose wavelength is near the wavelength of green laser beams, but allows laser beams with other wavelength to pass through. The beam splitter 43 may reflect the red laser beams and laser beams whose wavelength is near the wavelength of red laser beams, but allows laser beams with other wavelength to pass through. The beam splitter 45 may reflect the blue laser beams and laser beams whose wavelength is near the wavelength of blue laser beams, but allows laser beams with other wavelength to pass through. In this embodiment, green laser beams and laser beams whose wavelength is near the wavelength of the green laser beams are emitted from the green laser chip 23; red laser beams and laser beams whose wavelength is near the wavelength of the red laser beams are emitted from the red laser chip 22; blue laser beams and laser beams whose wavelength is near the wavelength of the blue laser beams are emitted from the blue laser chip 21.

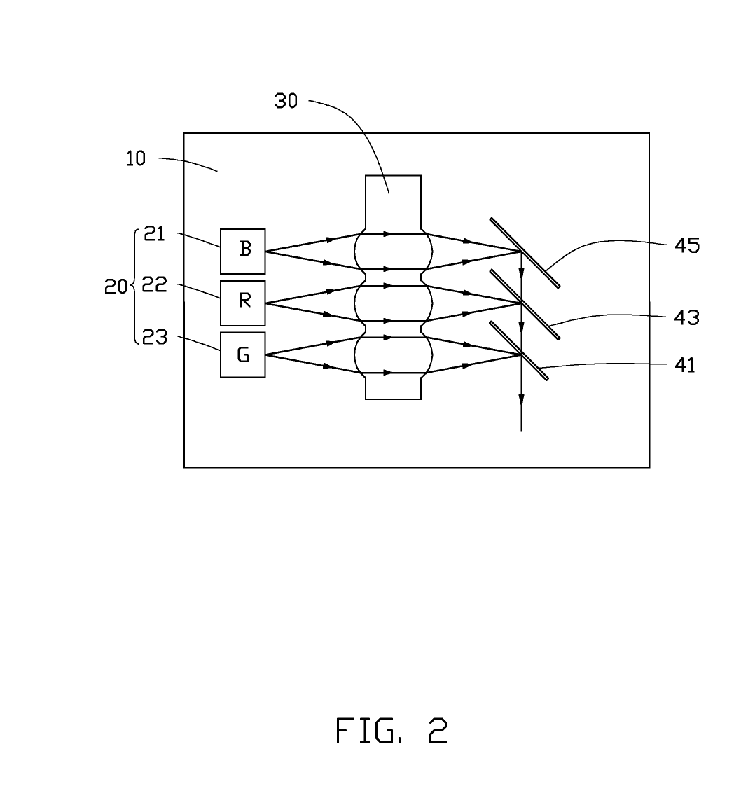

Referring to FIG. 2, when the laser projection device 100 works, the blue laser beams emitted from the blue laser chip 21 are refracted by the corresponding first light concentrating part 33 to become parallel blue laser beams. The parallel blue laser beams travel through the main body 31 to the corresponding second light concentrating part 35. The blue laser beams travelled to the second light concentrating part 35 are concentrated on the beam splitter 45 by the second light concentrating part 35. And then, the concentrated blue laser beams on the beam splitter 45 are reflected by the beam splitter 45 to pass through the beam splitters 43, 41 sequentially.

Similarly, the concentrated red laser beams on the beam splitter 43 are reflected by the beam splitter 43 to pass through the beam splitter 41. And the concentrated green laser beams on the beam splitter 41 are reflected by the beam splitter 41 to mix with the reflected blue laser beams passing through the beam splitters 43, 41 sequentially and the reflected red laser beams passing through the beam splitter 41. The mixed laser beams can be modulated into images on a screen by a photoelectric conversion device (not shown).

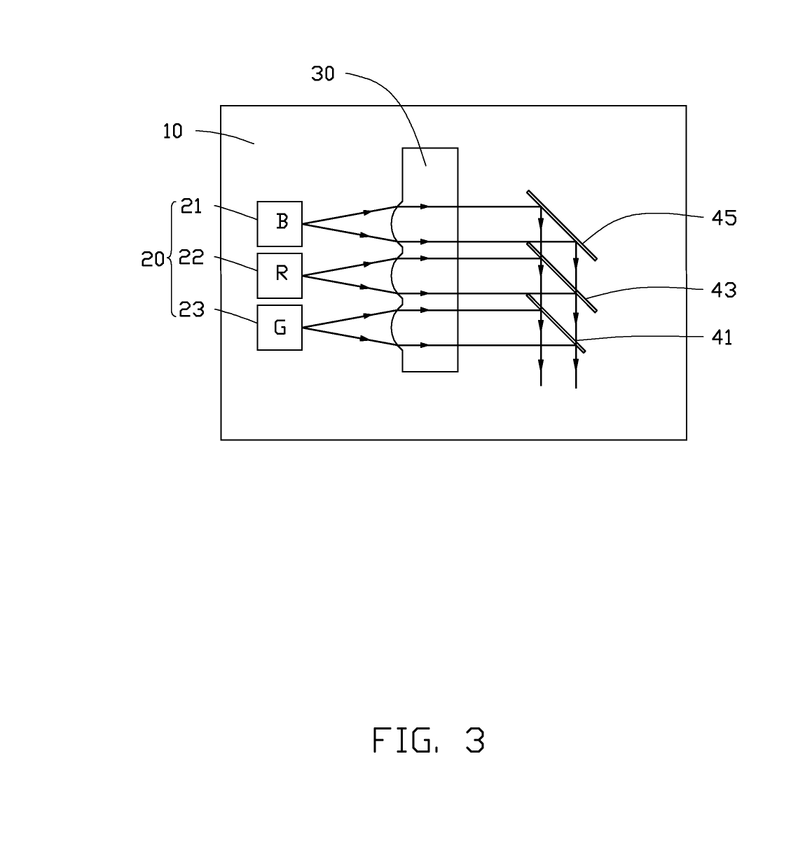

Referring to FIG. 3, in a second embodiment, the difference from the first embodiment is that no second light concentrating parts 35 are formed on a surface of the main body 31 facing the spectroscope 40. That is, the surface of the main body 31 facing the spectroscope 40 is flat. As such, parallel laser beams formed by the first light concentrating parts 33 directly travel through the main body 31 into the beam splitters 41, 43, 45 without a concentration by the second light concentrating parts 35. The parallel blue laser beams, the parallel red laser beams and the parallel green beams are reflected by corresponding beam splitters 41, 43, 45 to become a plurality of mixed parallel laser beams. The plurality of mixed parallel laser beams may be concentrated by a light concentrating lens (not shown). In the second embodiment, laser beams emitted from the laser chips 21, 22, 23 are refracted by the corresponding first light concentrating parts 33 to become parallel laser beams, respectively. As such, an interference of the laser beams is reduced.

Firstly, according to the laser projection device 100 of this disclosure, the blue laser chip 21, the red laser chip 22 and the green laser chip 23 are directly mounted on the single substrate 10 instead of mounted on three substrates to be packaged as three individual laser LED packages; as such, a bulk of the projection laser device 100 and a cost of manufacturing the projection laser device 100 are reduced. Secondly, the lens 30 is located on light paths of the blue laser chip 21, the red laser chip 22 and the green laser chip 23. As such, the laser beams emitted from the laser chips 21, 22, 23 are refracted by the corresponding first light concentrating parts 33 of the lens 30 to become parallel laser beams, which may reduce an interference of the laser beams. The parallel laser beams concentrated on the spectroscope 40 by the corresponding second light concentrating parts 35 make a brightness of the laser beams concentrated on the spectroscope 40 increased, which also reduces a diffusion of the laser beams. Thirdly, according to the projection laser device 100 of this disclosure, for the blue laser chip 21, the red laser chip 22 and the green laser chip 23 being mounted on the substrate 10 together, only one lens 30 is enough to refract the laser beams emitted from the laser chips 21, 22, 23, which makes the bulk of the laser projection device 100 reduced.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A laser projection device comprising:
a substrate;
a plurality of laser chips mounted on the substrate, each laser chip being a laser diode;
a spectroscope arranged on laser beams paths of the laser chips; and
a lens located between the laser chips and the spectroscope;
wherein laser beams emitted from the laser chips are refracted convergently into the spectroscope by the lens.

2. The laser projection device of claim 1, wherein the lens comprises a plurality of first light concentrating parts, and the first light concentrating parts are used to refract the laser beams from the laser chips to parallel laser beams.

3. The laser projection device of claim 2, wherein the first light concentrating parts are formed on a surface of the lens facing the laser chips, and spaced from each other.

4. The laser projection device of claim 3, wherein each of the first light concentrating parts is aligned with a corresponding laser chip.

5. The laser projection device of claim 4, wherein the first light concentrating parts are protruding from the lens toward the laser chips.

6. The laser projection device of claim 5, wherein each of the first light concentrating parts is hemispherical.

7. The laser projection device of claim 6, wherein the lens further comprises a plurality of second light concentrating parts used to concentrate the parallel laser beams on the spectroscope.

8. The laser projection device of claim 7, wherein the second light concentrating parts are formed on a surface of the lens facing the spectroscope, and each of the second light concentrating parts is corresponding with one of the first concentrating parts.

9. The laser projection device of claim 8, wherein the spectroscope comprises a plurality of beam splitters corresponding with the laser chips, and the parallel laser beams from the laser chips are concentrated on the beam splitters.

10. The laser projection device of claim 9, wherein the beam splitters are slantwise and top ends thereof are oriented toward the laser chips, and an angle defined between each of the beam splitters and a top end of the substrate is varied between 10° to 45°.

11. The laser projection device of claim 8, wherein each of the first light concentrating parts is a Fresnel lens and each of the second light concentrating parts is a Fresnel lens.

12. The laser projection device of claim 1, wherein the laser chips comprise at least a blue laser chip, a red laser chip and a green laser chip.

13. A laser projection device comprising:
a substrate;
a plurality of laser chips mounted on the substrate;
a spectroscope arranged on laser beams paths of the laser chips; and
a lens located between the laser chips and the spectroscope, wherein the lens comprises a plurality of first light concentrating parts formed on a surface facing the laser chips, by which, laser beams emitted from the laser chips are refracted to become parallel laser beams.

14. The laser projection device of claim 13, wherein the first concentrating parts are spaced from each other, and each of the first concentrating parts is corresponding with a laser chip.

15. The laser projection device of claim 14, wherein each of the first light concentrating part is a hemisphere.

16. The laser projection device of claim 13, wherein the lens further comprises a plurality of second light concentrating parts formed on a surface facing the spectroscope, and the second light concentrating parts are used to concentrate the parallel laser beams on the spectroscope.

17. The laser projection device of claim 16, wherein the second light concentrating parts are spaced from each other and the each second light concentrating part is corresponding with a first light concentrating part.

18. The laser projection device of claim 16, wherein each of the first light concentrating parts is a Fresnel lens and each of the second light concentrating parts is a Fresnel lens.

19. The laser projection device of 13, wherein the spectroscope comprises a plurality of beam splitters, the beam splitters are corresponding with the laser chips, and parallel laser beams are concentrated on the beam splitters by the second light concentrating parts.

20. The laser projection device of 13, wherein the lens comprises a main body, the first light concentrating parts and the second light concentrating parts are formed on opposite sides of the main body and symmetrical with a central axis of the main body.
